(19) United States
(12) Patent Application Publication
(10) Pub. No.: US 2003/0142691 A1
(43) Pub. Date: Jul. 31, 2003

(54) Modulation by multiple pulse per group keying and method of using the same

(75) Inventor: Clinton S. Hartmann, Dallas, TX (US)

Correspondence Address: HITT GAINES P.C., P.O. BOX 832570, RICHARDSON, TX, 75083, US

(73) Assignee: RF SAW Components, Incorporated, Dallas, TX

(21) Appl. No.: 10/066,173

(22) Filed: Jan. 30, 2002

(51) Int. Cl. H04B 7/212

(52) U.S. Cl. 370/442; 370/458

(57) ABSTRACT

The present invention provides for a propagated signal using multiple pulse per group keying and a method of using the same. In one embodiment the propagated signal includes: (1) an element of data contained within a time period of the propagated signal, the time period divided into a group of time slots; and (2) multiple pulses distributed in a predetermined manner among the time slots by pulse group keying to encode the data.

### TECHNICAL FIELD OF THE INVENTION

The present invention is directed, in general, to a propagated signal and, more specifically, to a propagated signal containing data modulated by multiple pulse per group modulation and a method of using the same.

### BACKGROUND OF THE INVENTION

Electronic data transmission requires some form of signal modulation that encodes data onto an information bearing signal so that the signal can be propagated over a transmitting medium and demodulated to unambiguously recover the data originally encoded. Modulation can be viewed as the process by which digital data, voice, music, and other “intelligence” is added to radio waves produced by a transmitter so that the intelligence is in a form suitable for propagation. Modulation can also be viewed as the addition of information to an electronic or optical signal carrier in a manner that permits the encoded data to be reliably decoded. Modulation can be applied to direct current (mainly by turning it on and off), to alternating current, and to optical signals. One can even view blanket waving as a form of modulation used in smoke signal transmission (the carrier being a steady stream of smoke). Morse code, invented for telegraphy and still used in amateur radio, is a method of modulation that uses a binary (two-state) digital code similar to the code used by modern computers.

Modulation implies the occupancy of bandwidth, a precious resource the conservation of which is of increasing importance to all but most particularly to those in the data and information transmission business. Bandwidth conservation requirements has increased the pressure on users to make the most efficient use of bandwidth as technology permits. One method to increase bandwidth efficiency is to utilize transmission techniques that maximize the amount of data or information that is transmitted over a limited period of time. One way to increase the amount of data transmitted over a limited time period is to utilize those modulation methods that maximize encoded data transmitted over the allocated time period.

A number of methods are now being used to modulate electronic signals to transmit digital data. For most radio and telecommunication uses, the carrier being modulated is alternating current (AC) within a given range of frequencies. Some of the more common modulation methods include: amplitude modulation (AM), in which the amplitude of the carrier signal is varied over time; frequency modulation (FM), in which the frequency of the carrier signal is varied; and phase modulation (PM), where the phase of the carrier signal is varied over time. These are all classified as continuous wave modulation methods in order to distinguish them from the pulse code modulation (PCM) methods used to encode digital and analog information in a binary way. There are also more complex forms of modulation, such as phase shift keying (PSK) and quadrature amplitude modulation (QAM), as well as methods to modulate optical signals by applying an electromagnetic current that varies the intensity of a laser beam.

Depending on the intended use, all the foregoing methods of modulation permit a relatively reliable transmission of electronic data over a distance. However, as more and more bandwidth is being used because of a constantly increasing amount of data to be transmitted, there exists a need for even more efficient data transmission capability. As more information is digitized, even more pressure is exerted on transmission systems and bandwidth demand. Although improved equipment and technology is of some help in resolving the problems caused by an increased demand for bandwidth, other solutions are also required.

One way to partially resolve the problem of limited bandwidth is to encode more data on the carrier. If the amount of data transferred over a limited period of time is increased, the infrastructure and equipment required to support such infrastructure can be significantly reduced.

Thus, what is required in the art are new and novel methods to modulate electronic signals that increase the amount of digital data that can be transferred and the rate at which such transfer can occur.

### SUMMARY OF THE INVENTION

To address the above-discussed deficiencies of the prior art, the present invention provides for a propagated signal using multiple pulse per group keying and a method of using the same. In one embodiment the propagated signal includes: (1) an element of data contained within a time period of the propagated signal, the time period divided into a group of time slots; and (2) multiple pulses distributed in a predetermined manner among the time slots by pulse group keying to encode the data.

The present invention therefore introduces the broad concept of employing more than one pulse in a group of slots that occupy a time period in a propagated signal. This produces a dramatic increase in the amount of data that can be encoded on a propagated signal. Such increase produces a significant and substantial increase in data transmission capability over that of prior art data modulation methods.

In one embodiment of the invention the element of data in the group of time slots is ascertainable by mapping. In another embodiment of the invention the time slots in a group are adjacent while in another the time slots in the group are not adjacent. In yet still another embodiment of the invention, the time slots in the propagated signal have differing characteristics thus permitting unequal slot times and an increased versatility of use.

In another embodiment of the invention, a group of time slots in the propagated signal encode data that is more than fifteen bits long. As will be recognized by those of ordinary skill in the pertinent art, a data element that is fifteen bits long permits a large number of unique codes to be encoded therein.

In a particularly useful embodiment of the invention, the element of data in the propagated signal is selected from the group consisting of a header; an error detection message; a synchronization element and a data message. Of course, as will be understood by those of ordinary skill in the pertinent art, most propagated signals will probably contain each of these data elements.

Another embodiment of the invention provides for the propagated signal to be further comprised of a plurality of time periods. The versatility of the present invention also permits a propagated signal having a plurality of time periods that contain varying information. Another aspect of this embodiment provides for the number of pulses encoding data to utilize differing numbers of multiple pulses in different groups of slots within the same propagated signal. For example, a header data element may require the use of four pulses to encode data, while one of the data elements carrying actual information may require six, seven or even eight pulses to encode data. Further evidence of the versatility of the present invention is found in an embodiment where the number of time slots can vary in the time periods that make up the propagated signal.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a representation of a time period in a propagated signal where an element of data is modulated using an embodiment of the present invention; and

FIGS. 2A-2D illustrate graphs of pulse positions for a conventional prior art digital pulse position modulation (PPM) method where data is encoded by a pulse located in one of four pulse positions;

FIG. 3 illustrates the group of four slots separately illustrated in FIGS. 2A-2D, showing the correct conventional PPM pulse position for each pulse; and

FIG. 4 illustrates a block diagram of a computer network using an embodiment of the present invention to transmit and receive information via the Internet.

### DETAILED DESCRIPTION

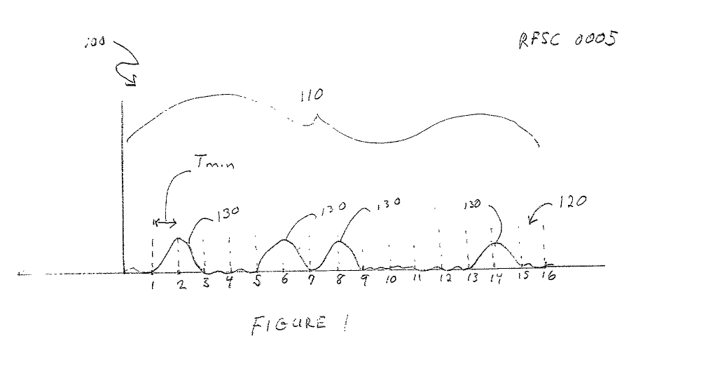

Referring initially to FIG. 1, illustrated is a representation of a time period 100 in a propagated signal where an element of data is modulated using an embodiment of the present invention. The element of data within the time period 100 is divided into a group 110 of time slots 120 (one of which is indicated). The group 110 is represented by a collection of time slots 120. Each time slot 120 is centered on a possible pulse 130 position (defined below) in the group 110. The illustrated group 110 has sixteen time slots 120, although, as will be recognized by those of ordinary skill in the pertinent art, a group 110 can consist of any number of time slots 120 and be well within the intended scope of the present invention.

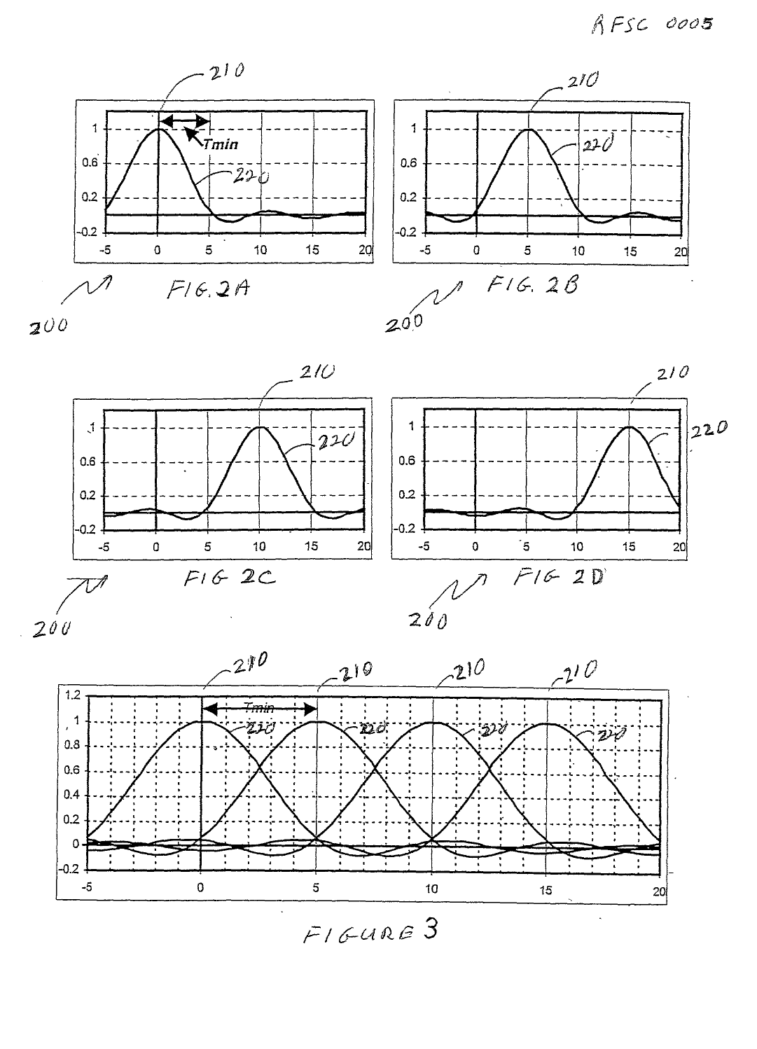

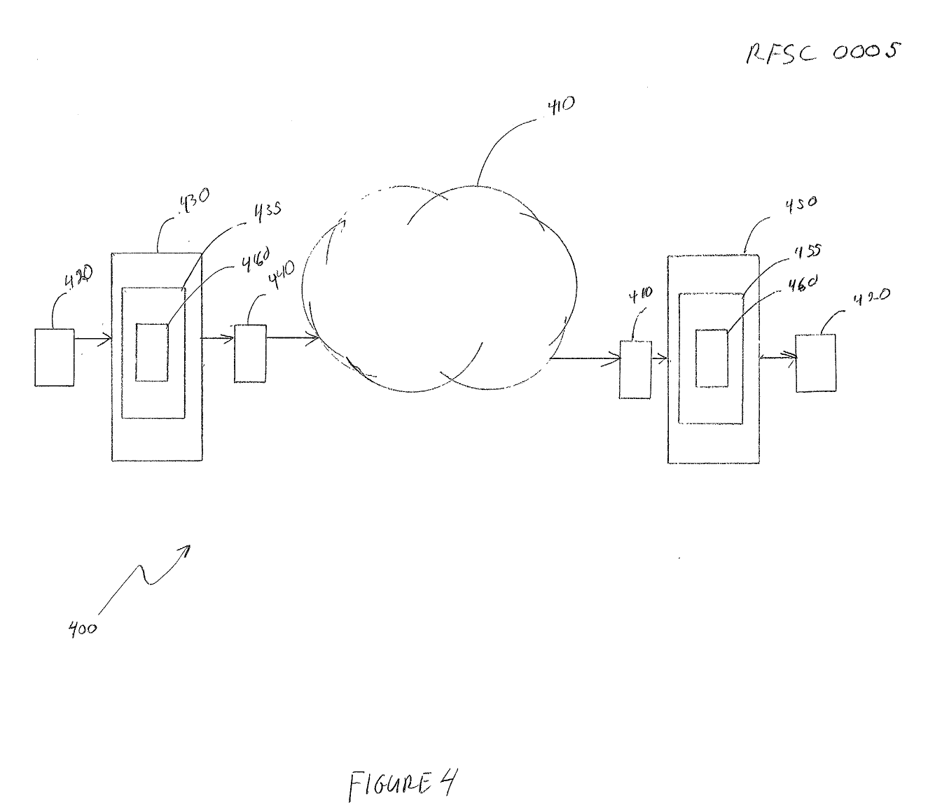

Turning now to FIGS. 2A-2D, illustrated are graphs 200 of pulse positions 210 for a conventional prior art digital pulse position modulation (PPM) method where data is encoded by a pulse 220 located in one of four pulse positions 210. Conventional prior art PPM provides for a stream of data divided into separate sample values and then transmitting each sample value with a single pulse 220 therein. Illustrated in FIGS. 2A-2D are the four possible values, or pulse positions 210, of a pulse 220 within a discrete sample value represented by a span of time. The four pulse positions 210 can also be viewed as being located in a group of four slots.

By changing the position of the pulse 220 within the group of slots over the discrete time period, the data or information in the sample is encoded. A series of pulse position 210 transmissions is now used to transmit an entire stream of data. Single pulses 220 in subsequent time spans similarly transmit the information contained in subsequent sample values.

Turning now to FIG. 3, illustrated is the group of four slots separately illustrated in FIGS. 2A-2D, showing the correct conventional PPM pulse position 210 for each pulse 220. As noted above, conventional PPM provides for the transmission of only one pulse 120 in a group. When demodulation sampling is performed at each allowable peak pulse position 210 in the group, three of the samples will have a value of essentially zero and the correct sample will a value or amplitude of unity. If sampling during demodulation is not properly synchronized to these peak positions, however, then the pulse 220 amplitude at the “correct” pulse position 210 will start decreasing while the amplitude at a neighboring location will become larger than zero.

It is readily apparent that to assure a reliable transmission of data, there are a number of factors that must be considered. One of which is the minimum time interval between pulse positions 210. As a general rule, PPM requires the minimum time interval between pulse positions 210 to be sufficiently large enough to ensure that the skirt of a neighboring pulse 220 is essentially zero at the peak of an adjacent pulse 220. Illustrated in FIG. 2A and FIG. 3 is Tmin, which is the generally recognized minimum time spacing or separation between allowable peak pulses 220 required for PPM. Tmin is designed to improve the ability during demodulation sampling of being able to accurately identify a particular pulse 220 and separate it from the “intersymbol” interference, if any, caused by close or adjacent pulses 220.

Another factor to consider for reliable transmission of data is the synchronization of the timing of sampling to potential pulse positions 210. If sampling is not properly synchronized to pulse positions 210 or if the pulse 220 is not properly within its intended slot, the amplitude for the “correct” pulse position 210 will be less than unity, while the amplitude at a neighboring location will become larger than zero. Even if this were to occur, however, the signal most probably can still be correctly demodulated because PPM generally provides for only a single pulse 220 to be transmitted during the period of time that constitutes a group of slots.

Timing error becomes more of a problem if significant noise exists in the system. The probability of incorrect demodulation sampling is increased when system noise is combined with substantial timing errors. On the other hand, if the timing error is small, the signal can usually be demodulated even with the presence of significant noise. As a general rule, unless the signal to noise ratio is very poor (small), the signal can be successfully demodulated as long as the timing error is less than Tmin/2.

Although PPM is widely used, the amount of data that can be encoded within a discrete time period is significantly limited. The present invention provides for a new and novel method of modulation that permits a number of pulses 220 to be included in a group of slots. This feature permits substantially more data to be encoded and transmitted within a given discrete time increment.

Turning again to FIG. 1, distributed among the group 110 of sixteen time slots 120 are multiple pulses 130 represented by waveforms, which pulses 130 can be any type of energy signal known in the art. Each illustrated pulse 130 has an identical waveform centered in one of the group's 110 four time slots 120 or pulse positions. The pulses 130 are distributed in a predetermined manner to encode the group 110 with an element of data that can be reliably ascertained when the signal is decoded or demodulated. To code and decode the location of each pulse 130 within the group 110 so that data can be reliably recovered, the signal must be synchronized by using any one of a number of synchronization methods known in the art. Each time slot 120 containing a pulse 130 can be separated by Tmin although, in some cases to permit more pulses in a group, the separation can be less than Tmin if the noise level is sufficiently small and synchronization is particularly good.

If one time slot 120 among the illustrated sixteen time slots 120 is occupied by a pulse 130, four bits of data can be encoded in the group 110 and sixteen different data states can be produced. However, if, as provided by the present invention, more than one time slot 120 in the group 110 is occupied by a pulse 130, the number of states produced in the group 110 is significantly increased. For example, with four pulses 130 in the group 110, as illustrated in FIG. 1, there are 1,820 different data states that can be produced. This represents a dramatic and significant increase in the number of states that can be encoded over the number that could be encoded using prior art PPM. Further, if eight pulses 130 can be used in a group 110 of sixteen time slots 120, there are 12,870 data states that become available, which is an even more significant improvement. Even more dramatic results can be obtained if seven, eight, or even nine pulses 130 in a group 110 of sixteen time slots 120 are used, which permits as many as 35,750 different data states. This permits a number of different data states to be encoded in sixteen time slots 120 to correspond to more than 15 bits of data, which, as will be recognized by those of ordinary skill in the pertinent art, is significant.

The invention described herein provides for several embodiments. One such embodiment provides that all time slots 120 do not have to be identical (they can have unequal slot widths, pulse amplitudes, etc., for example) nor do the time slots 120 necessarily have to be adjacent to one another. A single group 110 can be defined such that it only has a fixed number of occupied time slots 120 or, alternatively, it might allow for a varying number of occupied time slots 120. A single data message could include more than one type of group 110 (for example a header might be one type of group, actual data could be in a second type of group, a synchronization element in a third type, and an error detection/correction word might be in a fourth type). These are all variants that are within the intended scope of the present invention.

Thus the present invention is best characterized as using multiple pulses 140 in a group 110 of time slots 120 arranged in a manner that encodes data. By mapping the encoded data, such data can be reliably decoded or demodulated. Mapping constitutes a predetermined arrangement or agreement whereby an encoded data message or signal has a specific meaning attributable to it that can be ascertained when the data message or signal is demodulated. This arrangement or agreement can take the form of a protocol, such as an agreed upon table of codes, whereby a certain encoded signal has a reliable and ascertainable meaning when it is decoded. The advantage of using the present invention to encode a data message is clear. A vast amount of information can be encoded on data elements within a propagated signal that permits the transfer of substantial data over a very short period of time, thus conserving bandwidth.

Turning now to FIG. 4, illustrated is a block diagram of a computer network 400 using an embodiment of the present invention to transmit and receive information via the Internet 210. Although the illustrated example shows a computer network 400 in conjunction with the Internet 410, it would be equally applicable to an application involving a Local Area Network (“LAN”), a Wide Area Network (“WAN”), an intranet, an extranet, a generalized internet, any combination thereof, and many others.

In the illustrated embodiment, a data message 420 is entered into a first computer 430. A modem 440 associated with the first computer 430 transmits the data message 420 via the Internet 410 to a modem 440 associated with a second computer 450 where the data message 420 is decoded and delivered. In order to code and decode the data message 420, a predetermined agreement or protocol 460 regarding the mapping of possible pulse arrangements that encode will have been entered into a data bank 435 in the first computer 430 as well as a data bank 455 in the second computer 450. The mapping protocol 460 enables the first computer 430 to encode or modulate a data message 420 using the present invention and the second computer 450 to demodulate and recover the same data message 420. Mapping assures that the data message 420 received is the same as the data message 420 transmitted.

The advantage of using the present invention for encoding and transmitting data messages 420 is clear. The propagated signal described herein allows a vast amount of data to be encoded on data elements within the signal and permits the transfer of such data message 420 over a very short period of time, thus conserving bandwidth.

The present invention also provides several embodiments of methods for propagating a signal. In one such embodiment the method calls for forming an element of data within a time period of the propagated signal by dividing the time period into a group of time slots. The method then provides for distributing multiple pulses in a predetermined manner among the time slots by pulse group keying to encode the data in the specified time period. The invention includes several other embodiments of methods for propagating a signal. Sufficient detail has been set forth herein to enable one of ordinary skill in the pertinent art to understand and practice the various embodiments of such methods.

Although the present invention has been described in detail, those skilled in the art should understand that they can make various changes, substitutions and alterations herein without departing from the spirit and scope of the invention in its broadest form.

What is claimed is:

1. A propagated signal, comprising:
an element of data contained within a time period of said propagated signal, said time period divided into a group of time slots; and
multiple pulses distributed in a predetermined manner among said time slots by pulse group keying to encode said data.

2. The propagated signal as recited in claim 1 wherein said data is ascertainable by mapping.

3. The propagated signal as recited in claim 1 wherein said time slots in said group are adjacent.

4. The propagated signal as recited in claim 1 wherein said time slots in said group are not adjacent.

5. The propagated signal as recited in claim 1 wherein said time slots have differing characteristics.

6. The propagated signal as recited in claim 1 wherein said group encodes data that is more than fifteen bits long.

7. The propagated signal as recited in claim 1 wherein said element of data is selected from the group consisting of:
a header;
an error detection message;
a synchronization element; and
a data message.

8. The propagated signal as recited in claim 1 further comprising a plurality of said time periods.

9. The propagated signal as recited in claim 8 wherein said groups have differing numbers of multiple pulses.

10. The propagated signal as recited in claim 8 wherein said number of time slots vary in said time periods.

11. A method of propagating a signal, comprising:
forming an element of data within a time period of said signal, said time period divided into a group of time slots; and
distributing multiple pulses in a predetermined manner among said time slots by pulse group keying to encode said data.

12. The method as recited in claim 11 wherein said data is ascertainable by mapping.

13. The method as recited in claim 11 wherein said time slots in said group are adjacent.

14. The method as recited in claim 11 wherein said time slots in said group are not adjacent.

15. The method as recited in claim 11 wherein said time slots have differing characteristics.

16. The method as recited in claim 11 wherein said group encodes data that is more than fifteen bits long.

17. The method as recited in claim 11 wherein said element of data is selected from the group consisting of
a header;
an error detection message;
a synchronization element; and
a data message.

18. The method as recited in claim 11 further comprising designating a plurality of said time periods.

19. The method as recited in claim 18 wherein said groups have differing numbers of multiple pulses.

20. The method as recited in claim 18 wherein said number of time slots vary in said time periods.
